(19) United States
(12) Patent Application Publication
(10) Pub. No.: US 2005/0191384 A1
(43) Pub. Date: Sep. 1, 2005

(54) Hunter's breath masking flavor for use in chewing gum and the like

(76) Inventors: Neil A. Bretl, Antigo, WI (US); Bruce D. Heuss, Milwaukee, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/050,414

(22) Filed: Feb. 3, 2005

Related U.S. Application Data
(60) Provisional application No. 60/542,502, filed on Feb. 6, 2004.

(51) Int. Cl. A23G 3/30

(52) U.S. Cl. 426/3

(57) ABSTRACT

A chewing gum or similar orally ingested carrier suitable for masking the breath of a hunter includes as an essential ingredient an evergreen oil. A conventional chewing gum base may be utilized and the evergreen oils are preferably selected from one or a mixture of spruce essence oil, fir needle oil and scotch pine oil. Other buffering additions to the flavoring may be utilized, such as tea tree oil and grapefruit oil.

### CROSS REFERENCE TO RELATED APPLICATION

The present application is based on and claims priority to U.S. Provisional Application Ser. No. 60/542,502, filed Feb. 6, 2004.

### BACKGROUND OF THE INVENTION

It is well known that hunters utilize many devices to hide or disguise themselves from detection by wild game that is being hunted. Hunters utilize camouflage clothing, cover or color exposed skin to blend in with the camouflage or with their surroundings, and avoid the use of scented soaps, colognes or the like. However, a substantial portion of human scent detectable by game animals such as deer is generated by a person's breath. Thus, the use of all of the known and commonly used means for masking and/or disguising a hunter is often for naught because the hunter's presence is detected by the hunter's breath. A means for disguising and/or masking a hunter's breath would add considerably to the other means of providing camouflage, disguise or stealth for a hunter. This can be especially important for close range hunters, such as bow hunters.

### SUMMARY OF THE INVENTION

The breath of a hunter is disguised from detection by wild game by the incorporation into a chewing gum, candy, toothpaste or the like, essential oils of one or more evergreen trees, the smell of which is common and not alarming to wild game. The essential oils may be selected from spruce, fir needle or scotch pine essences, or combinations thereof, as well as other essential oils of evergreens. Juniperberry oil may also be utilized. The strong and bitter flavor of these oils is tempered by the additional use of tea tree oil, sage oil or grapefruit oil, or combinations thereof. Sweeteners are used in the gum base. The gum base may comprise any suitable gum formulation typically used for chewing gums. An optional cooling flavor may also be utilized. As indicated above, the oil formulation of the present invention may be incorporated into other oral compositions, including hard candy, a coating for an edible product, mouth wash, toothpaste and the like. The essential ingredient is at least one of the evergreen essence oils, i.e. spruce, fir needle and scotch pine.

### DETAILED DESCRIPTION OF THE PREFERRED EMBODIMENT

The following is a list of the ingredients, by weight percent, of one gum and flavoring formulation that is particular effective:

| | Wt. % |
|---|---|
| Gum: | |
| Gum Base | 44.28 |
| Sorbitol | 43.03 |
| Xylitol | 9.74 |
| Softener | 1.77 |
| Chlorophyll | 0.01 |
| Resinous Glaze | 0.01 |
| Carnauba Wax | 0.01 |
| Flavors | |
| N & A Cooling Flavor | 0.20 |
| Spruce Essence Oil | 0.23 |
| Fir Needle Oil | 0.23 |
| Scotch Pine Oil | 0.19 |
| Tea Tree Oil | 0.05 |
| Sage Oil | 0.10 |
| Grapefruit Oil | 0.10 |
| Juniperberry Oil | 0.05 |

The gum into which the evergreen oil flavoring formulation is added is not particularly important and may comprise any type of chewing gum formulation of the many kinds well known in the art. The gum may include the artificial sweeteners, as shown, or may use natural sugar sweeteners and the like. Chlorophyll is preferably used for its known characteristics of being absorbed into the body to mask body scent generally, in addition to masking the breath. All of the above essential oils are defined by the USFDA as generally recognized as safe (GRAS).

In the foregoing listing of ingredients in a presently preferred formulation of gum and flavors, the flavors including the essential evergreen oils comprise 1.15 wt. % of the entire formulation. It is believed that an effective gum or other orally ingested carrier containing the flavors would be effective down to about 0.30 wt. % of the flavors, predominated by at least one of the evergreen essence oils. A gum formulation, such as that disclosed above, would be effective to mask a hunter's breath from wild game if the flavor composition contained only a single one of the evergreen oils, i.e. spruce essence oil, fir needle oil, or scotch pine oil. All of the remaining components of the flavor formulation are optional, but the use of all of them is preferred. The tea tree oil, grapefruit oil and sage oil, though also inherently bitter, tend to temper the bitterness of the evergreen oil or oils to provide a more true evergreen taste. In addition, tea tree oil and sage oil add longevity to the flavor. It is preferred to use at least one of the foregoing three tempering oils. Juniperberry oil is optional, but is also believed to provide a tempering affect to the bitterness of the evergreen oils. It is believed that an upper limit on the amount of flavoring oils is about 2.5 wt. %, above which the gum base will not hold the oil.

The essential oils listed in the above flavoring formulation are generally prepared by steam distillation in a well known manner. Grapefruit oil, however, is pressed from grapefruit peelings. There follows a recipe for producing a breath masking gum with a somewhat different formulation than set forth above, but in accordance with the present invention:
1) 12 tablespoons of powdered sorbitol and 1 tablespoon of “World Organic Liquid Chlorophyll” were heated to give a thick, nearly saturated green syrup.
2) 2.5 cups of pelletized bubble gum base was heated to melting point.
3) 6 tablespoons of the chlorophyll syrup from step #1 was worked into the melted gum base. A homogenous green gum results.
4) The following flavors were added and worked into the hot gum base:
   a) 1 teaspoon of “spruce essence” (spruce base flavor available from Rainbow flavors, Inc., P.O. Box 22, Osage Beach, Mo. 65065)
   b) 1 teaspoon each of the following essential oils: fir needle (Abies balsamea) oil, scotch pine (Pinus sylvestris) essential oil,
   c) ¼ teaspoon of tea tree (Melaleuca alternifolia) oil d) ½ teaspoon sage (Salvia Lavandula) oil
   e) ½ teaspoon grapefruit essential oil (cold pressed from the peels of ripe grapefruit)
   f) ¼ teaspoon juniper berry (Juniperus communis) essential oil
5) With intermittent heating added and worked into hot gum base 6 tablespoons of granular xylitol. Mixed until homogenous.
6) The gum is rolled out into a sheet, allowed to cool, and then cut into squares.
7) The gum is then coated (by tumbling in a container) with the following candy syrup: ¼ cup of granular xylitol dissolved in 2 teaspoons of “World Organic Liquid Chlorophyll” (heating is required). ¼ teaspoon of Scotch pine essential oil is added to this green syrup.
8) The still-wet syrup-coated gum is then coated (by shaking in container) with the following dry, pulverized candy powder: ½ cup xylitol is dissolved in one teaspoon of “World Organic Liquid Chlorophyll” (heating is required) . ½ teaspoon scotch pine essential oil and ¼ teaspoon of vegetable oil is added. The mixture is heated with stirring until a homogenous green syrup is obtained. This syrup is allowed to cool to a hard solid and then is pulverized.
9) The candy coated gum is then allowed to dry in front of a fan for one hour at room temperature.

In its most basic embodiment, the flavoring oil of the present invention may be utilized in its preferred embodiment in a gum base, or incorporated into a hard candy, mouth wash, toothpaste, or a coating for some other type of edible product. The flavoring oil may be comprised entirely of one of the indicated evergreen oils, but preferably comprises two of the evergreen oils and, more preferably, all three in approximate equal parts. It is also preferable to use at least one of tea tree oil, sage oil and grapefruit oil to temper the bitterness of the evergreen oil or oils. Juniperberry oil may also be utilized for this purpose, but is believed to be of lesser significance. It is also preferred to use a cooling flavor, however this additive is optional. Suitable cooling flavors may be selected, for example, from any of the various isomers of menthol.

In the first above described gum and flavoring formulation, the flavoring comprises 1.15 wt. % of the total formulation. The flavoring composition may, however, lie in the range of about 0.3 to 2.5 wt. % of the entire gum and flavoring formulation. More preferably, the flavoring should lie in the range of about 0.5 to 2.0 wt. %. Thus, if only a single evergreen essential oil is used for the flavoring, it would preferably comprise about 1.15 wt. % of the total gum/flavor formulation. However, the proportion of the single oil could lie anywhere in the range of about 0.3 to 2.5 wt. % and, more preferably, in the range of about 0.5 to 2.0 wt. %. Similarly, if two or more of the other evergreen essential oils are combined, their total proportions should lie in the above defined ranges. Corresponding, the addition of other preferred oils, such as the tea tree oil, sage oil, grapefruit oil or juniperberry oil would similarly be utilized in a manner that would permit the total flavor formulation to fall within the indicated ranges.

In addition to the three preferred evergreen oils, other similar oils such as hemlock (Tsuga Canadensis), white pine (Pinus strobus L.), dwarf pine (Pinus mugo Turra var.) and fir pine (abies sibirica) may be used

1. A chewing gum for masking a person's breath, comprising:
chewing gum base comprising about 97.5 wt.% to about 99.7 wt.%; and
about 0.3 wt.% to about 2.5 wt.% evergreen oil flavoring.

2. A chewing gum as set forth in claim 1 wherein the evergreen oil flavoring comprises about 0.5 to about 2.0 wt.%.

3. A chewing gum as set forth in claim 1 wherein the evergreen oil flavoring comprises about 1.18 wt.%.

4. A chewing gum as set forth in claim 1 wherein the evergreen oil is selected from the group comprising spruce oil, fir needle oil, and juniper berry oil.

5. A chewing gum as set forth in claim 1 wherein the evergreen oil is selected from the group comprising spruce oil, fir needle oil, scotch pine oil, hemlock oil, white pine oil, dwarf pine oil, balsam fir oil, and juniper berry oil.

6. A chewing gum as set forth in claim 1 wherein the evergreen oil comprises a mixture of spruce oil, fir needle oil, and juniper berry oil.

7. A chewing gum as set forth in claim 6 wherein each of the oils is provided in equal parts.

8. A chewing gum as set forth in claim 1 including an oil selected from the group comprising tea tree oil and grapefruit oil.

9. A chewing gum as set forth in claim 1 including a mixture of tea tree oil and grapefruit oil.

10. A chewing gum as set forth in claim 9 wherein the mixture comprises approximately 0.19 wt.%.
